(19) United States
(12) Patent Application Publication
(10) Pub. No.: US 2025/0308193 A1
(43) Pub. Date: Oct. 2, 2025

(54) SYSTEM AND METHOD FOR PERFORMING SALIENT OBJECT SEGMENTATION

(71) Applicant: SAMSUNG ELECTRONICS CO., LTD., Suwon-si (KR)

(72) Inventors: Biplab Ch DAS, Bengaluru (IN); Shouvik DAS, Bengaluru (IN); Kiran Nanjunda IYER, Bengaluru (IN); Venkat Narasimham JOSYULA, Bengaluru (IN)

(73) Assignee: SAMSUNG ELECTRONICS CO., LTD., Suwon-si (KR)

(21) Appl. No.: 19/236,414

(22) Filed: Jun. 12, 2025

Related U.S. Application Data
(63) Continuation of application No. PCT/KR2025/001503, filed on Jan. 24, 2025.

(30) Foreign Application Priority Data
Mar. 8, 2024 (IN) 202441016882

(51) Int. Cl. G06V 10/26; G06V 10/82; G06V 10/98

(52) U.S. Cl. CPC G06V 10/26; G06V 10/82; G06V 10/993

(57) ABSTRACT

A method of performing saliency segmentation for a preview image frame, including: receiving the preview image frame from an imaging unit, generating a plurality of saliency boxes including one or more salient subjects, for each of a plurality of subjects in the preview image frame, selecting, from among the plurality of saliency boxes, a set of saliency boxes including a first set of salient subjects based on a ranking of each saliency box from among the plurality of saliency boxes, and extracting one or more salient images along with boundary information corresponding to each salient subject from among the first set of salient subjects.

### CROSS-REFERENCE TO RELATED APPLICATIONS

This application is a continuation of International Application No. PCT/KR2025/001503 designating the United States, filed on Jan. 24, 2025, in the Korean Intellectual Property Receiving Office and claiming priority to Indian Patent Application number 202441016882, filed on Mar. 8, 2024, in the Indian Intellectual Property Office, the disclosures of each of which are incorporated by reference herein in their entireties.

### BACKGROUND

### 1. Field

The present disclosure relates to image processing, and more particularly, to a saliency segmentation method of subjects in preview images and a system thereof.

### 2. Description of Related Art

Salient object segmentation may refer to a computer vision technique that aims to identify and separate salient objects from the background in an image. Salient objects may be the most visually prominent and significant elements within a scene, and may draw immediate attention from viewers. These objects may have unique characteristics such as vivid colors, high contrast, or distinct textures that set them apart from their surroundings. Salient object segmentation plays an important role in various applications such as image and video editing, object recognition, and autonomous driving. By accurately isolating salient objects, salient object segmentation may enhance visual content analysis and improve the performance of computer vision systems in understanding and interpreting visual data.

Salient subjects in the images may be of different shapes, types, and sizes. Understanding and segmenting each of the objects correctly requires a good understanding of the context and detailed information about the subjects in the scene. However, due to various factors, such as imprecise boundary detection, misclassification of pixels, or failure to differentiate objects from their backgrounds result in poor segmentation of the subjects in the image. This affects the user experience.

Further, many neural networks use computation-heavy neural networks to produce good-quality segmentation masks, which makes it difficult to use them for real-time applications, for example, in mobile devices. Further, in a case when models with less complexity are being used for saliency segmentation, poor-quality segmentation may occur. This results in displaying a poor-quality salient object. Thus, poor quality segmentations may diminish the overall effectiveness and user satisfaction with applications implemented in any electronic device.

Accordingly, there is a need for a technique that may overcome various aforesaid issues.

### SUMMARY

This summary is provided to introduce a selection of concepts in a simplified format that are further described in the detailed description of the present disclosure. This summary is not intended to identify key or essential inventive concepts of the invention, nor is it intended to determine the scope of the invention.

In accordance with an aspect of the disclosure, a method of performing saliency segmentation for a preview image frame includes: receiving the preview image frame from an imaging unit, generating a plurality of saliency boxes including one or more salient subjects, for each of a plurality of subjects in the preview image frame, selecting, from among the plurality of saliency boxes, a set of saliency boxes including a first set of salient subjects based on a ranking of each saliency box from among the plurality of saliency boxes, and extracting one or more salient images along with boundary information corresponding to each salient subject from among the first set of salient subjects.

The generating of the plurality of saliency boxes may include: providing the preview image frame as input to a neural network (NN) model, detecting, using the NN model, the plurality of subjects in the preview image frame, assigning, using the NN model, a score to each subject included in the plurality of subjects, detecting, using the NN model, the one or more salient subjects from among the plurality of subjects based on the assigned score, and generating, using the NN model, the plurality of saliency boxes.

The selecting of the set of saliency boxes may include: performing an analysis on the plurality of saliency boxes by applying one or more pre-determined ranking parameters to the one or more salient subjects and the plurality of saliency boxes, ranking the plurality of saliency boxes based on a result of the analysis and the one or more salient subjects, and selecting the set of saliency boxes from among the plurality of saliency boxes based on the ranking.

The first set of salient subjects may be selected from the one or more salient subjects, and the one or more pre-determined ranking parameters may include at least one of location information about each saliency box, a dimension of each saliency box, and a type of a subject included in each saliency box.

The extracting may include: providing the type of the subject corresponding to each saliency box, and the first set of salient subjects, as input to the NN model; segmenting, using the NN model, the one or more salient images; and extracting the one or more salient images along with the boundary information corresponding to each salient subject subjects based on a result of the segmenting.

The method may further include determining whether a quality of the one or more salient images is higher than a predetermined quality threshold value, and displaying a salient image from among the one or more salient images based on determining that the quality of the one or more salient images is higher than the predetermined quality threshold value.

The determining the quality of the one or more salient images may include: calculating a quality metric value corresponding each salient image from among the one or more salient images, comparing the quality metric value of each salient image with the predetermined quality threshold value, and determining whether the quality metric value of each salient image is higher than the predetermined quality threshold value based on a result of the comparing, and the quality metric value may indicate the quality of the one or more salient images.

In accordance with an aspect of the disclosure, an electronic device for performing saliency segmentation for a preview image frame includes: one or more processors; and a memory configured to store instructions which, when executed by the one or more processors, cause the electronic device to: receive the preview image frame from an imaging unit of the electronic device, generate a plurality of saliency boxes including one or more salient subjects, for each of a plurality of subjects in the preview image frame, select, from among the plurality of saliency boxes, a set of saliency boxes including a first set of salient subjects based on a ranking of each saliency box from among the plurality of saliency boxes, and extract one or more salient images including a second set of salient subjects along with boundary information of the second set of salient subjects based on a segmentation of images corresponding to each salient subject from among the first set of salient subjects.

To generate the plurality of saliency boxes having one or more salient subjects, the instructions may further cause the one or more processors to: provide the preview image frame as input to a neural network (NN) model, detect, using the NN model, the plurality of subjects in the preview image frame, assign, using the NN model, a score to each subject included in the plurality of subjects in the preview image frame, detect, using the NN model, the one or more salient subjects from among the plurality of subjects based on the assigned score, and generate, using the NN model, the plurality of saliency boxes.

To select the set of saliency boxes having the first set of salient subjects, the instructions may further cause the one or more processors to: perform an analysis on the plurality of saliency boxes by applying one or more pre-determined ranking parameters to the one or more salient subjects and the plurality of saliency boxes, rank the plurality of saliency boxes based on a result of the analysis, and select the set of saliency boxes from the plurality of saliency boxes based on the ranking.

The first set of salient subjects may be selected from the one or more salient subjects, and wherein the one or more pre-determined ranking parameters may include at least one of location information about each saliency box, a dimension of each saliency box, and a type of a subject included in each saliency box.

To extract the one or more salient images along with the boundary information of the second set of salient subjects, the instructions may further cause the one or more processors to: provide the type of the subject corresponding to each saliency box and the first set of salient subjects as input to the NN model, segment, using the NN model, the one or more salient images, and extract the one or more salient images along with the boundary information corresponding to each salient subject based on a result of the segmenting.

The instructions may further cause the one or more processors to: determine whether a quality of the one or more salient images is higher than a predetermined quality threshold value, and display a salient image from among the one or more salient images based on determining that the quality of the one or more salient images is higher than the predetermined quality threshold value.

To determine the quality of the one or more salient images, the instructions may further cause the one or more processors to: calculate a quality metric value corresponding to each salient image from among the one or more salient images, compare the quality metric value of each salient image with the predetermined quality threshold value, and determine whether the quality metric value of each salient image is higher than the predetermined quality threshold value based on a result of the comparing, wherein the quality metric value indicates the quality of the one or more salient images.

In accordance with an aspect of the disclosure, a computer-readable recording medium stores computer-executable instructions that, when executed by one or more processors of an electronic device for performing saliency segmentation for a preview image frame, cause the electronic device to: receive the preview image frame from an imaging unit, generate a plurality of saliency boxes including one or more salient subjects, for each of a plurality of subjects in the preview image frame, select, from among the plurality of saliency boxes, a set of saliency boxes including a first set of salient subjects based on a ranking of each saliency box from among the plurality of saliency boxes, and extract one or more salient images along with boundary information corresponding to each salient subject from among the first set of salient subjects.

To further clarify advantages and features of the present invention, a more particular description of the invention is provided herein with reference to some specific embodiments thereof, as well as the appended drawings. It should be appreciated that these drawings depict only some embodiments of the invention, and are therefore not to be considered limiting. Embodiments are described and explained with additional specificity and detail with reference the accompanying drawings.

### BRIEF DESCRIPTION OF THE DRAWINGS

These and other features, aspects, and advantages of the present disclosure will become better understood when the following detailed description is read with reference to the accompanying drawings, in which like characters represent like parts throughout the drawings, and in which:

FIG. 1 illustrates an exemplary general architecture of an apparatus for performing a saliency segmentation method, according to an embodiment of the present disclosure;

FIG. 2 illustrates various components of modules of FIG. 1, according to an embodiment of the present disclosure;

FIG. 3 illustrates a method for saliency segmentation for a preview image frame, according to an embodiment of the present disclosure;

FIG. 4 illustrates a method for generating the saliency boxes including the one or more salient subjects, according to an embodiment of the present disclosure;

FIGS. 5A and 5B illustrate examples of detecting one or more salient subjects, according to embodiments of the present disclosure;

FIG. 6 illustrates method for selecting the set of saliency boxes having the first set of salient subjects, according to an embodiment of the present disclosure;

FIG. 7 illustrates method for extracting at least one or more salient image along with boundary information corresponding to each salient object from among the first set of salient subjects, according to an embodiment of the present disclosure;

FIG. 8 illustrates a hybrid NN architecture for generating a segmentation mask of the input image, according to an embodiment of the present disclosure;

FIG. 9 illustrates an example of the NN fusion model, according to an embodiment of the present disclosure;

FIGS. 10A and 10B illustrate examples of determining the quality value of the one or more salient images, according to embodiments of the present disclosure;

FIGS. 11A, 11B, and 11C illustrate various example images depicting a comparison of performance between embodiments of the present disclosure and a comparative example; and

FIGS. 12A and 12B illustrate examples of a quality assessment of the segmented image, according to embodiments of the present disclosure.

Further, those of ordinary skill in the relevant art will appreciate that elements in the drawings are illustrated for simplicity and may not be necessarily been drawn to scale. For example, the flow charts included in the drawings may illustrate the embodiments in terms of example steps or operations to help to improve understanding of aspects of the present disclosure. Furthermore, in terms of the construction of the device, one or more components of the device may be represented in the drawings by certain symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

It should be understood that although illustrative implementations of some embodiments of the present disclosure are described below and illustrated in the drawings, the present invention may be implemented using any number of techniques, whether currently known or in existence. The present disclosure should in no way be limited to the illustrative implementations, drawings, and techniques described below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein, such as but not limited to “includes,” “comprises,” “has,” “consists,” and grammatical variants thereof, do not specify an exact limitation or restriction, and do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Embodiments of the present invention are described below in detail with reference to the accompanying drawings.

According to an embodiment, the present disclosure relates to an electronic device for saliency segmentation for the preview image frame. According to an embodiment, the electronic device is implemented with intelligently fused low-resolution context information with high-resolution boundary information to produce high-quality object segmentations. According to a further embodiment, a neural network model is designed that provides a neural-heuristic quality metric to display salient subjects with improved quality. The displayed salient subjects may be used in various applications, such as object live focus, visual lookout, and the like.

Examples of detailed embodiments are explained in the following paragraphs of the disclosure.

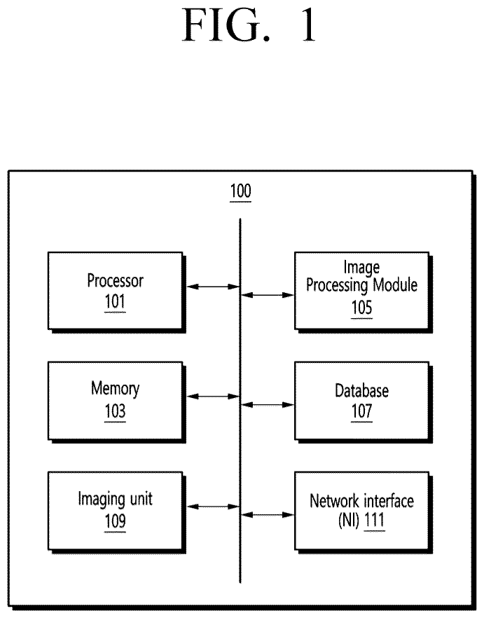

FIG. 1 illustrates an exemplary general architecture of an apparatus for performing a saliency segmentation method, according to an embodiment of the present disclosure. FIG. 1 describes various components of the apparatus 100 for performing the saliency segmentation method. In a non-limiting example, the apparatus 100 includes electronic devices such as smartphones, webcams, smart cameras, monitoring systems, or any electronic device capable of capturing images.

According to embodiment, the apparatus 100 includes one or more processors 101, a memory 103, an image processing module 105, a database 107, an imaging unit 109, and a network interface (NI) 111, which may be communicatively coupled with each other.

As an example, the processor 101 may be a single processing unit or a number of units, all of which could include multiple computing units. The processor 101 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 101 is configured to fetch and execute computer-readable instructions and data stored in the memory 103.

The memory 103 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

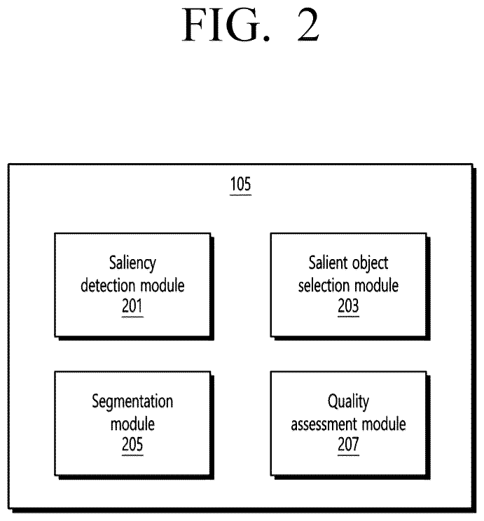

As an example, the module(s) 105 may include a program, a subroutine, a portion of a program, a software component, or a hardware component capable of performing a stated task or function. As used herein, the module(s) 105 may be implemented on a hardware component such as a server independently of other modules, or a module can exist with other modules on the same server, or within the same program. The module(s) 105 may be implemented on a hardware component such as processor one or more microprocessors, microcomputers, microcontrollers, digital signal processors, central processing units, state machines, logic circuitries, and/or any devices that manipulate signals based on operational instructions. The module(s) 105, when executed by the processor(s) 101, may be configured to perform any of the described functionalities of the module(s) 105. Examples of various components of module(s) 105 are explained in more detail below with reference to FIG. 2.

As a further example, the database 107 may be implemented with integrated hardware and software. The hardware may include a hardware disk controller with programmable search capabilities or a software system running on general-purpose hardware. The examples of the database 107 are, but are not limited to, in-memory databases, cloud databases, distributed databases, embedded databases, and the like. The database 107, amongst other things, serves as a repository for storing data processed, received, and generated by one or more of the processors, and the modules/engines/units.

In an embodiment, the module(s) 105 may be implemented using one or more AI modules that may include a plurality of neural network layers. Examples of neural networks include but are not limited to, Convolutional Neural Network (CNN), Deep Neural Network (DNN), Recurrent Neural Network (RNN), and Restricted Boltzmann Machine (RBM). According to some embodiments, the module(s) 105 may be implemented using one or more generative AI modules that may include Variational Autoencoders (VAEs), Generative Adversarial Networks (GANs), flow-based generative model, auto-regressive models, and the like. Further, ‘learning’ may be referred to in the disclosure as a method for training a predetermined target device using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB, VAES, GANS, flow-based generative models, auto-regressive models, and the like may be implemented to thereby achieve execution of the present subject matter's mechanism through an AI model or generative AI models. A function associated with an AI module or the generative AI models may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors or neural processors control the processing of the input data in accordance with a predetermined operating rule or artificial intelligence (AI) model or generative AI models stored in the non-volatile memory and the volatile memory. The predefined operating rule or artificial intelligence model is provided through training or learning.

As an example, the imaging unit 109 may include cameras to receive real-time images or preview images. Further, according to some embodiments, the imaging unit 109 may receive images from the database 107 or from the memory 103. The imaging unit 109 may further include a display unit to display the real-time images or images received from the database 107 or from the memory as the preview image. Further, the display unit of the imaging unit 109 is further configured to display salient images. As a further example, the NI unit 111 establishes a network connection with a network like a home network, a public network, a private network, a cloud server, and the like for communication purposes.

FIG. 2 illustrates various components of modules of FIG. 1, according to an embodiment of the present disclosure. As shown in FIG. 2, the module(s) 105 of the apparatus 100 includes a saliency detection module 201, a salient object selection module 203, a segmentation module 205, and a quality assessment module 207. The forthcoming paragraphs will describe a brief description and operation of elements included in the image processing module 105 with reference FIGS. 2 through 12. According to some embodiments, various operations of the elements included in the image processing module 105 can be performed by the processors 101 upon executing a set of instructions. Further, one or more of the image processing module 105 and the elements included therein may be uniquely designed as a specific circuit. In an embodiment, the explanation of the disclosed methodology will be made by referring to various components of modules for the ease of understanding. Further, the reference numerals are kept the same for similar components for ease of understanding.

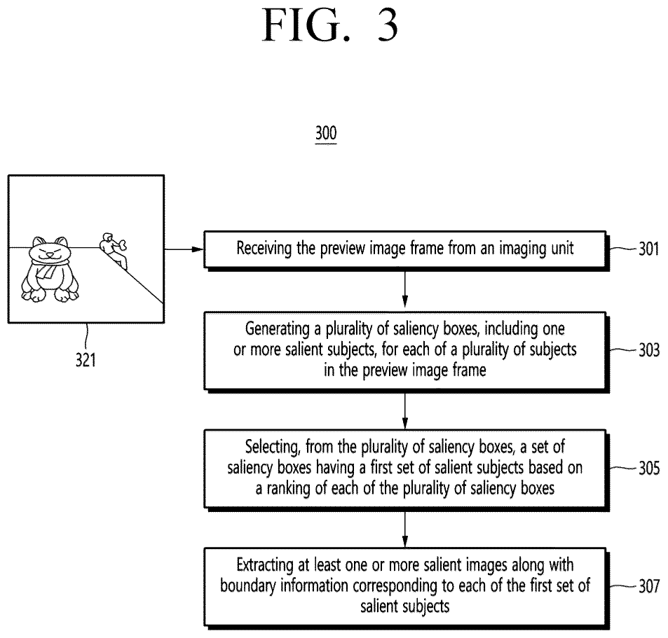

FIG. 3 illustrates a process 300 for saliency segmentation for a preview image frame, according to an embodiment of the present disclosure. According to an embodiment, the imaging unit 109, at operation 301, receives a preview image frame 321. In a non-limiting example, the preview image frame 321 may be received during the capturing of images or videos through a camera (e.g., the camera included in the imaging unit 109). According to an embodiment, the preview image frame 321 is then passed on to the saliency detection module 201 for further processing. According to an embodiment, the saliency detection module 201 is implemented with a neural network (NN) model for extracting features from the preview image frame 321, detecting the salient subjects in the preview image frame 321, generating saliency boxes including one or more salient subjects, and providing scores to the salient subjects. The preview image frame may also be referred to as an input image. An example of the detailed operation of the saliency detection module 201 is explained in the forthcoming paragraphs.

According to an embodiment, at step 303, the saliency detection module 201 generates one or more saliency boxes, including one or more salient subjects, for each of a plurality of subjects included in the preview image frame 321.

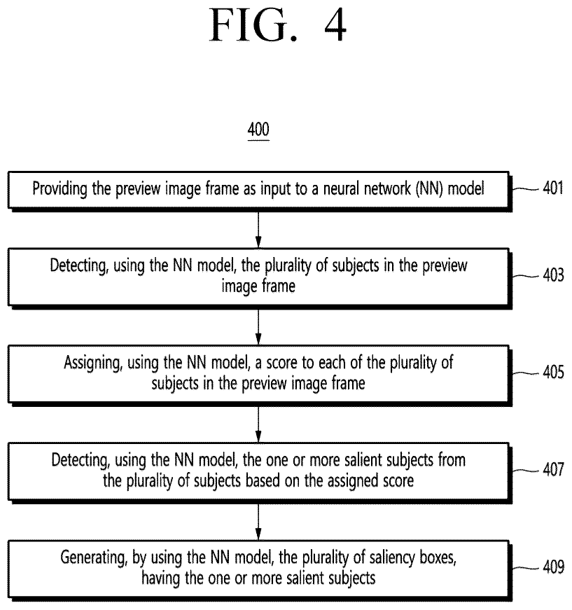

FIG. 4 illustrates a process 400 for generating the saliency boxes including the one or more salient subjects, according to an embodiment of the present disclosure. The method 400 may correspond to an example of a detailed operation of step 303. In an embodiment, after receiving the preview image frame 321 from the imaging unit 109, at step 401, the preview image frame 321 is fed into the NN model. In embodiments, feeding the preview image frame 321 into the NN model may refer to providing the image frame 321 as input to the NN model, or otherwise inputting the image frame 321 to the NN model. Further, the NN model identifies and extracts meaningful features from the preview image frame 321. In a non-limiting example, the NN model may be a convolutional neural network (CNN) model. The meaningful features may include both low-level features and high-level features. For example, low-level features may correspond to features such as edges, corners, and lines, and high-level features may correspond to features such as shapes and textures. According to an embodiment, shapes may be, for example, flower, tree, cat, dog, etc. In an embodiment, the CNN model automatically learns the meaningful features during training of the NN model.

According to an embodiment, the NN model outputs feature maps that represent the presence of specific visual patterns of edges, textures, higher-level structures etc. within the preview image frame 321. These feature maps encode the visual patterns in the preview image frame 321 such as edges, textures, higher-level structures, etc. Further, the saliency detection module 201, at step 403, detects one or more subjects in the preview image frame 321 using the NN model. For example, the detected one or more subjects in the example preview image frame 321 illustrated in FIG. 3 are a cat and a man. Further, the saliency detection module 201, at step 405, assigns a score to each of the plurality of subjects in the preview image frame 321 by using the NN model. In an embodiment, the NN model, which is used for saliency detection, predicts bounding box coordinates with a certain confidence, according to design of the NN model. For example, the more confident the NN model is about the presence of the object, the higher confidence is achieved during the prediction. The detection NN output format may correspond to [x1, y1, x2, y2, confidence], in which “x1, y1, x2, y2” denote coordinates corresponding to the bounding box, and “ ” denotes a confidence score. Further, the confidence score can have values in the range of [0,1], which may be referred to as a score. Thereafter, the saliency detection module 201, at step 407, detects the one or more salient subjects from among the plurality of subjects based on the assigned score. In an example preview image frame 321, that the cat may receive a score of seven (“7”) as the score, and the man may receive a score of five (“5”) as the score. Then, the saliency detection module 201 detects the cat as the salient subject based on a higher score compared to other subjects.

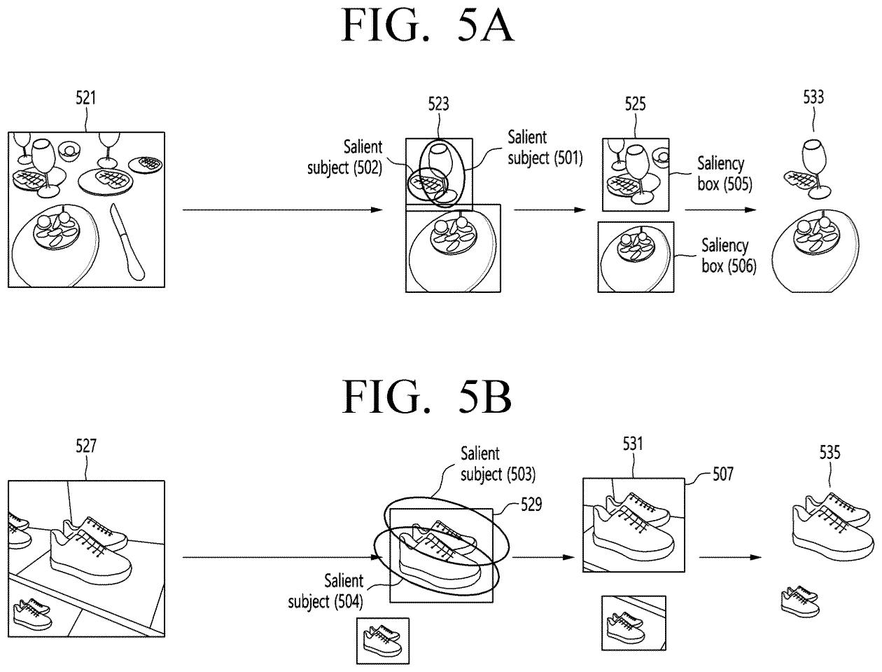

FIGS. 5A and 5B illustrates an examples of detecting one or more salient subjects, according to an embodiment of the present disclosure. As depicted in the FIG. 5A, when the input image frame 521 is passed through the NN model of the saliency detection module 201, the NN model, at bock 523, detects the one or more subjects, assigns the score to each of the subjects and detects one or more salient subjects based on the assigned score. As shown at block 523, the one or more salient subjects that are detected in the input image frame 521 are salient subject 501 and salient subject 502. As depicted in FIG. 5B, when the input image frame 527 is passed through the NN model of the saliency detection module 201, the NN model, at bock 529, detects the one or more subjects, assigns the score to each of the subjects and detects one or more salient subjects based on the assigned score. As can be seen at block 523, the one or more salient subjects that are detected in the input image frame 527 are salient subject 503 and salient subject 504.

Referring back to FIG. 4, after detecting one or more salient subjects, at step 409, the saliency detection module 201 generates the plurality of saliency boxes including the one or more salient subjects by using the NN model. Referring back to FIG. 5A, at block 525, the saliency boxes (e.g., saliency box 505 and saliency box 506) are generated where each of the saliency boxes includes one or more salient subjects. Likewise, As depicted in FIG. 5B, at block 531, the saliency boxes (e.g., saliency box 507) are generated where each of the saliency boxes includes one or more salient subjects.

Referring back to FIG. 3, at step 305, the salient object selection module 203 selects, from the plurality of saliency boxes, a set of saliency boxes having a first set of salient subjects based on a ranking of each of the plurality of saliency boxes.

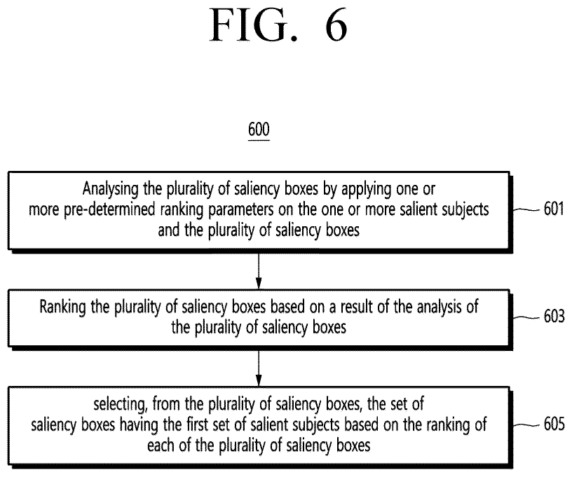

FIG. 6 illustrates process 600 for selecting the set of saliency boxes having the first set of salient subjects, according to an embodiment of the present disclosure. The method 600 may correspond to an example of a detailed operation of step 305. In an embodiment, after generating one or more saliency boxes as explained above, at step 601, the salient object selection module 203 analyses the plurality of saliency boxes by applying one or more pre-determined ranking parameters on the one or more salient subjects and the plurality of saliency boxes. Considering the example shown in FIG. 5A, the salient object selection module 203 analyses the saliency box 505 and saliency box 506. In a non-limiting example, the pre-determined ranking parameters may include at least one of location information of each saliency box, a dimension of each saliency box, and a type of the subject within each saliency box. Table 1 depicts an example of the type of subject and corresponding weights provided to each type of the subject to decide which type to prioritize in the final ranking of boxes.

TABLE 1

| Type | Weight |
|---|---|
| Human | 1.0 |
| Dogs & Cats | 0.95 |
| Flowers | 0.8 |
| Home Appliances | 0.7 |

In an embodiment, the analysis of the location information may assist in determining how much the saliency box is in the center of the preview image. For example, if the saliency box is in the center, then the apparatus 100 determines the possibility that the subject within it is the appropriate subject for segmentation. Similarly, the analysis of the dimension of each of the plurality of saliency boxes helps in determining an appropriate subject for segmentation. For example, a subject covering a larger area can be selected for segmentation. As another example, a subject that does covers a smaller area can be discarded for segmentation. Similarly, a subject with the type “human” may be provided more weightage than other types. Table 2 depicts a process for performing an analysis of the plurality of saliency boxes.

TABLE 2

Process
Input: Image shape (H, W), Box coordinates and their probability
(Bᵢ,i ∈[1,n]), Category Weight Table
For each i, x₁, y₁, x₂, y₂, Neural Score, Id = Bᵢ
Cy = 0.5 * (y₁ + y₂)/H; Cx = 0.5 * (x₁ + x₂)/W
Centerness = 1.0 − \sqrt{(Cx − 0.5)² +(Cy − 0.5)²}
$Area Score = \frac{( {y}_{2} - {y}_{1} )}{H} * \frac{( {x}_{2} - {x}_{1} )}{W}$
Combined Score = (0.6 * Centerness + 0.1 * Area Score + 0.3 *
Neural Score) * Category Weight[Id]
Output: Sorted Boxes Bᵢ based on Combined Score Sorting.

Accordingly, based on a result of the analysis of the plurality of saliency boxes and the one or more salient subjects, the salient object selection module 203 ranks the plurality of saliency boxes at step 603. Further, at step 605, the salient object selection module 203 selects, from the plurality of saliency boxes, the set of saliency boxes having the first set of salient subjects based on the ranking of each of the plurality of saliency boxes.

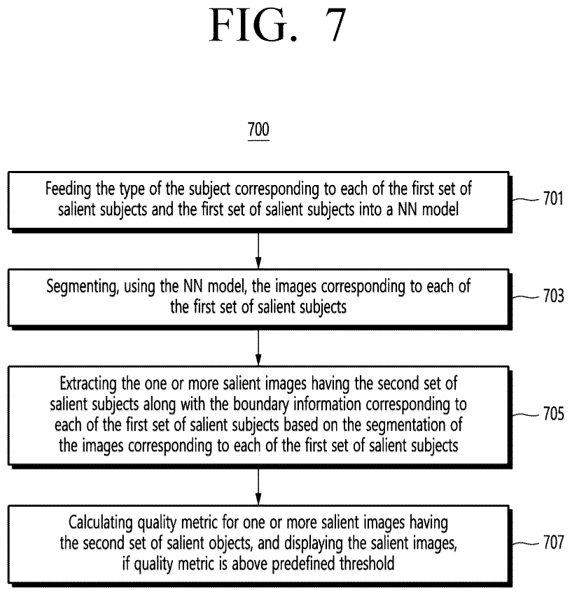

Referring back to FIG. 3, step 307, the segmentation module 205 extracts at least one or more salient images along with boundary information corresponding to each of the first set of salient subjects. FIG. 7 illustrates a process 700 for extracting at least one or more salient images along with boundary information corresponding to each of the first set of salient subjects, according to an embodiment of the present disclosure. Process 700 may correspond to an example of the detailed operation of step 607.

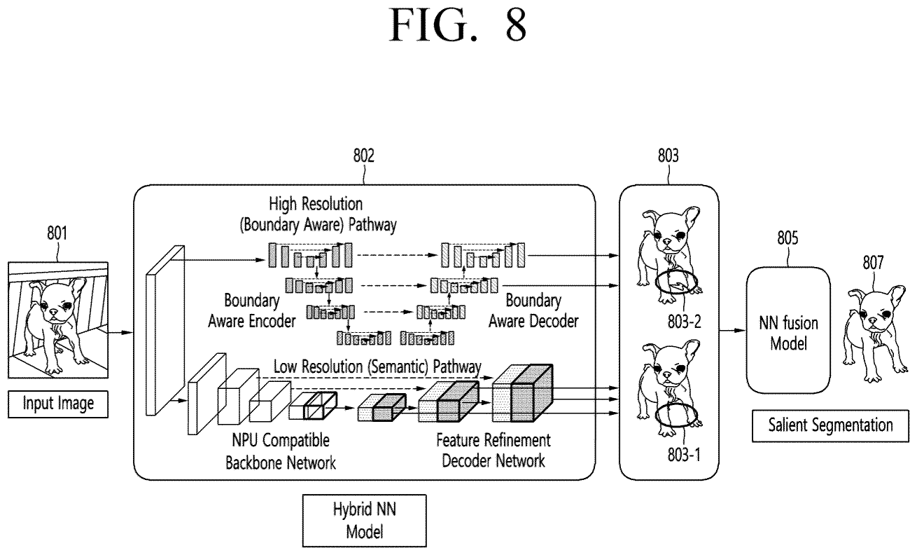

According to an embodiment, at step 701, the segmentation module 205 provides the type of the subject corresponding to each of the first set of salient subjects and the first set of salient subjects as input to the NN model. In a non-limiting example, a hybrid NN architecture as depicted in FIG. 8 is used herein. Further, in step 703, the segmentation module 205 segments, using the NN model, the images corresponding to each of the first set of salient subjects. Further, at step 705, the process 700 includes extracting the one or more salient images along with the boundary information corresponding to each of the first set of salient subjects based on the segmentation of the images corresponding to each of the first set of salient subjects. At step 707, the process 700 includes calculating a quality metric for one or more salient images having the second set of salient objects, and displaying the salient images, if quality metric is above predefined threshold.

FIG. 8 illustrates a hybrid NN architecture for generating a segmentation mask of the input image, according to an embodiment of the present disclosure. According to an example embodiment depicted in FIG. 8, the input image 801 is fed into the hybrid NN model 803. In embodiments, feeding the input image 801 into the NN model may refer to inputting the input image 801 to the NN model, or otherwise providing the input image 801 as input to the NN model. The hybrid NN model 803 includes a boundary-aware encoder, boundary-aware decoder, NPU-compatible backbone network, and feature refinement decoder network. In an embodiment, the hybrid NN model 803 gives a correct context of a pet (e.g., the bottom output 803-1) while missing some part of the boundary marked in a circle below the pet, and the boundary aware network gives correct boundary but extra spurious prediction marked in the circle at the top output 803-2. The NN fusion model 805 correctly combines both these predictions (e.g., the bottom output 803-1 and the top output 803-2) to generate the correct segmentation output mask 807.

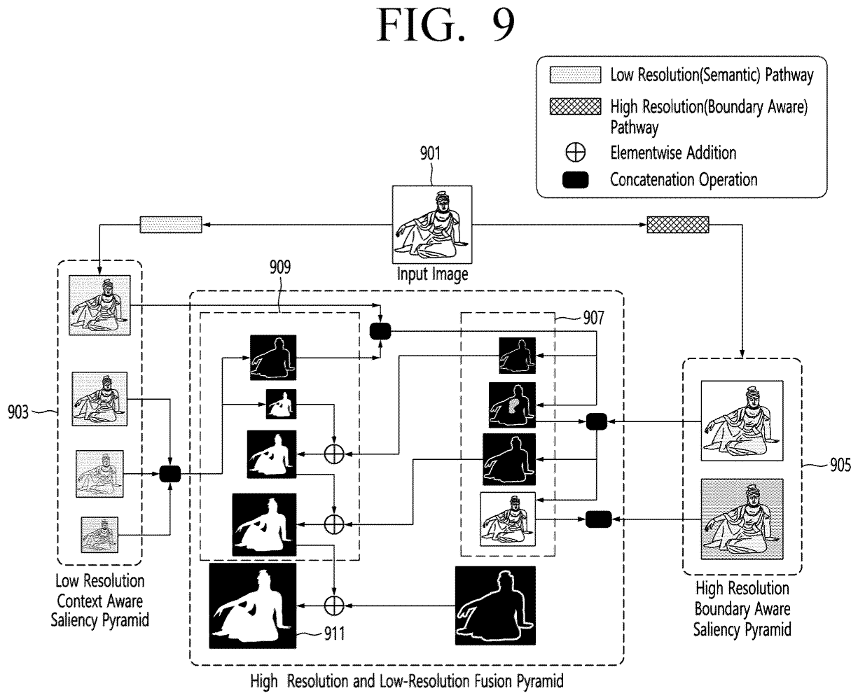

FIG. 9 illustrates an example of the NN fusion model, according to an embodiment of the present disclosure. The example of FIG. 9 is related to segmentation. The quality assessment module 207 is placed after segmentation module 205, and assigns a quality score to each of the segmentations predicted by the segmentation module 205. If the quality is higher than the pre-defined threshold, the segmentation result is displayed, else it is not displayed to user (e.g., in order to suppress bad/poor quality predictions). This links to the flowchart in FIG. 7, which takes segmentation output and provides the quality score, based on which display of segmentation output to user is performed.

More specifically, as depicted in FIG. 9, the input image 901 is provided to the NN fusion model 805, the input image 901 is converted into a low resolution context aware Saliency pyramid as depicted in block 903. Further, the input image 901 is also converted into a high resolution boundary aware saliency pyramid as depicted in block 905. Further, each of the outputs at blocks 903 and 905 are element-wise added and concatenated at blocks 907 and 909 to generate a segmentation mask 911. Block 907 depicts a high-resolution fusion pyramid, and block 909 depicts a low resolution fusion pyramid.

According to a further embodiment, the quality assessment module 207 concatenates the segmentation mask 911 with the input image, and a result of the concatenation is fed, inputted, or otherwise provided as input to a quality assessment neural network. In an embodiment, the quality assessment neural network is implemented in the quality assessment module 207. According to an example, the quality assessment neural network is trained with Pseudo Reward Generation technique. An example logic for the Pseudo Reward Generation technique is depicted in Table 3.

TABLE 3

A. Compute intersection over union (IOU) between prediction
and ground truth (GT) for available dataset
B. If IOU > 0.9, label as good else bad.

Here, after training, this NN automatically predicts quality value for the segmentation mask. The quality assessment module 207 generates a quality value based on which apparatus 100 decides whether to display the prediction or not.

According to an embodiment, the quality assessment module 207 determines whether the quality of the one or more salient images is higher than a predefined quality threshold value. Further, the quality assessment module 207 displays a salient image from the one or more salient images based on the determination that the quality of the one or more salient images is higher than the predefined quality threshold value.

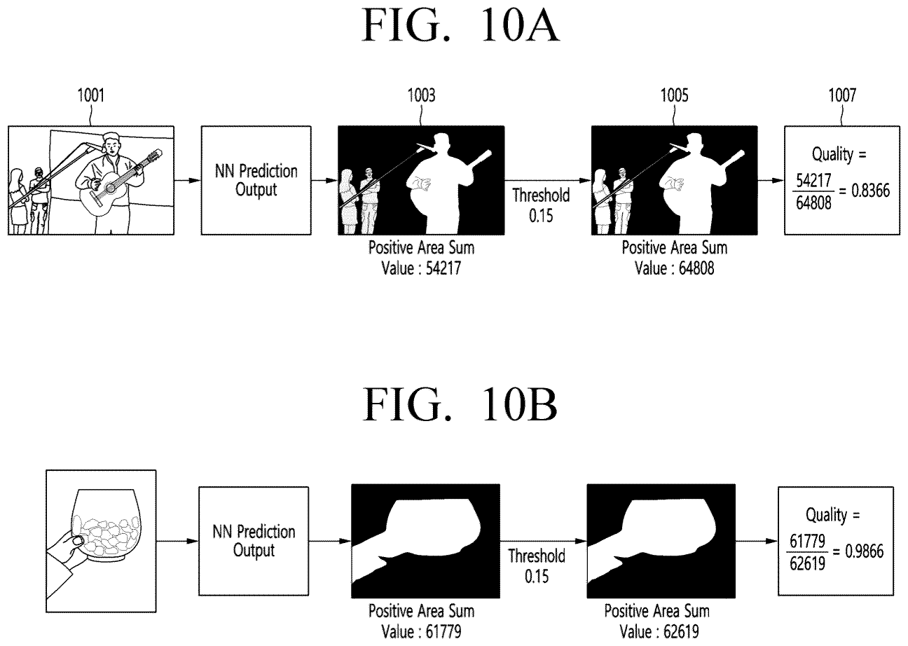

FIGS. 10A and 10B illustrate examples of determining the quality value of the one or more salient images, according to an embodiment of the present disclosure. According to the example shown in FIG. 10A, the prediction map is thresholded at 0.15 to generate the binary map. In an example embodiment, at block 1003, a positive area sum value of the outputted binary map of the hybrid NN model 903 may be 54217 for the input image 1001. Further, at block 1005, the positive area sum value of another outputted binary map of the hybrid NN model 903 may be 64808 for the input image 1001. In an embodiment, the area sum of both the maps when divided gives the quality value. An example expression for deriving the quality value is given by expressions in Table 4.

TABLE 4

If, BS = (S > 0.15),
Sum_1 = (BS * S).sum( )
Sum_2 = (BS).sum( )
Q = Sum_1/Sum_2

Accordingly, if the network predicts with higher probability in all the regions that the network considers foreground, the quality value will be higher (as in the example shown in FIG. 10A), and if the probability value is low over some predicted region, then the quality value gets low (as in the example shown in FIG. 10B). According to embodiments, a lower execution time may be achieved. Further, the disclosed method helps in providing better information for salient objects due to increase of the depth information.

In FIG. 10A, the random number 54217 is a sum of the values that are white and gray. Complete white regions contribute a value 1 to the sum, and gray regions contribute a value between 0 and 1 to the sum. When the sum of these gray and white values are taken in the middle image, that sum comes to 54217. While the white color means a value close to 1, the gray color means a value less than 1. So, the predicted region may be more white in case of a confident prediction, and the sum value may be higher. Otherwise, if there are more gray regions, then some values are less than 1, making the sum lower. Because this is a numerator of the division operation, lower value means low value after division, and hence lower quality (e.g., more gray regions). Therefore, more gray regions mean low quality, and after a threshold, it is not considered as a valid prediction.

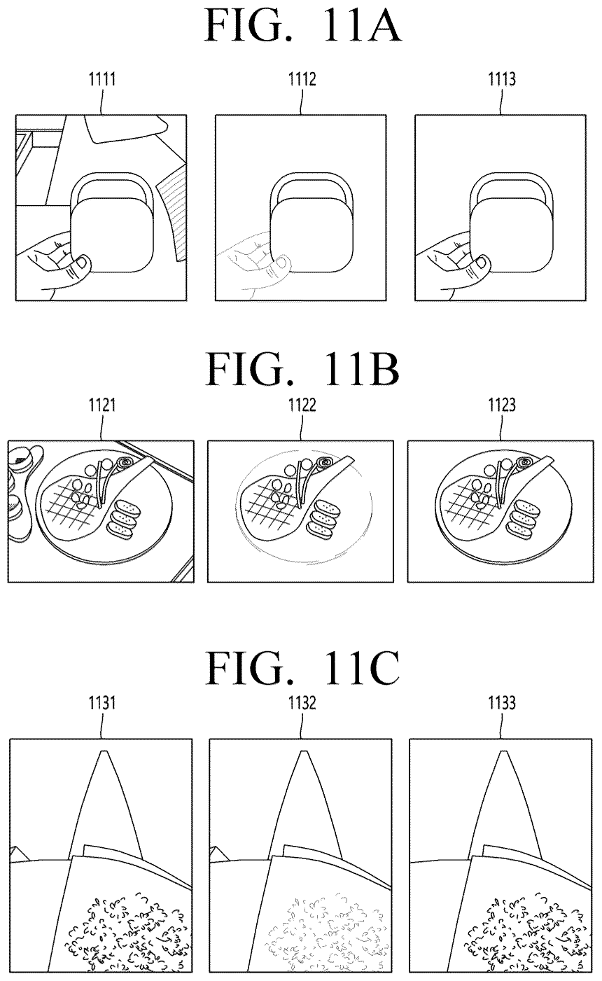

FIGS. 11A, 11B, and 11C illustrate various exemplary images depicting a comparison of performance between disclosed techniques and a conventional solution. In particular, FIG. 11A illustrates an original image 1111, a prediction 1112 according to a comparative example, and a prediction 1113 according to embodiments of the present disclosure. Similarly, FIG. 11B illustrates an original image 1121, a prediction 1122 according to a comparative example, and a prediction 1123 according to embodiments of the present disclosure. Further, FIG. 11C illustrates an original image 1131, a prediction 1132 according to a comparative example, and a prediction 1133 according to embodiments of the present disclosure.

In FIG. 11A, the prediction 1112 incompletely identifies the hand portion, resulting in a poor user experience, whereas the prediction 1113 accurately and includes both the hand and the speaker. In FIG. 11B, the prediction 1122 inadequately captures the plate, leading to subpar segmentation, whereas the prediction 1123 precisely identifies both the food and the plate. In FIG. 11C, the prediction 1132 overlooks the trees, creating gaps within the building, whereas the prediction 1133 successfully captures both the building and the trees (salient objects in the scene) in the segmentation result.

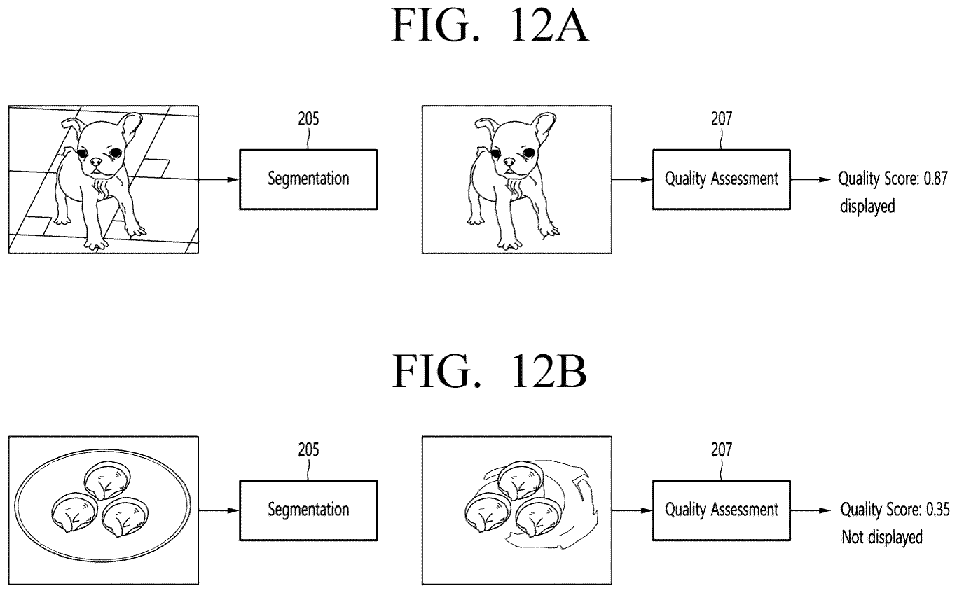

FIGS. 12A and 12B illustrate examples of a quality assessment of a segmented image, according to an embodiment of the present disclosure. In the example shown in FIG. 12A the quality assessment module 207 generates a quality score of 0.87. As this score surpasses the pre-defined quality threshold (considered as 0.6), apparatus 100 displays the segmentation output. In the example shown in FIG. 12B, the quality assessment module 207 yields a quality score of 0.35, which falls below the pre-defined quality threshold, leading to no display of the output. Therefore, in real-world testing scenarios, the quality metric assists in automatically identifying and suppressing poor segmentation predictions, consequently enhancing the user experience.

According to disclosed techniques, a lower execution time may be achieved. Further, the disclosed method assists in providing better (e.g., more accurate) information for salient objects due to increase of the depth information. Further, embodiments may effectively identify and segment the salient subject which may further pass through the quality assessment in order to display it.

While specific language has been used to describe embodiments of the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. In addition, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems are described above with regard to specific embodiments. However, the benefits, advantages, solutions to problems, and any component or components that may cause any benefit, advantage, or solution to occur or become more pronounced are not to be construed as a critical, required, or essential feature or component of any or all the claims.

What is claimed is:

1. A method of performing saliency segmentation for a preview image frame, the method comprising:
receiving the preview image frame from an imaging unit,
generating a plurality of saliency boxes comprising one or more salient subjects, for each of a plurality of subjects in the preview image frame,
selecting, from among the plurality of saliency boxes, a set of saliency boxes comprising a first set of salient subjects based on a ranking of each saliency box from among the plurality of saliency boxes, and
extracting one or more salient images along with boundary information corresponding to each salient subject from among the first set of salient subjects.

2. The method as claimed in claim 1, wherein the generating of the plurality of saliency boxes comprises:
providing the preview image frame as input to a neural network (NN) model,
detecting, using the NN model, the plurality of subjects in the preview image frame,
assigning, using the NN model, a score to each subject included in the plurality of subjects,
detecting, using the NN model, the one or more salient subjects from among the plurality of subjects based on the assigned score, and
generating, using the NN model, the plurality of saliency boxes.

3. The method as claimed in claim 1, wherein the selecting of the set of saliency boxes comprises:
performing an analysis on the plurality of saliency boxes by applying one or more pre-determined ranking parameters to the one or more salient subjects and the plurality of saliency boxes,
ranking the plurality of saliency boxes based on a result of the analysis and the one or more salient subjects, and
selecting the set of saliency boxes from among the plurality of saliency boxes based on the ranking.

4. The method as claimed in claim 3, wherein the first set of salient subjects are selected from the one or more salient subjects, and
wherein the one or more pre-determined ranking parameters include at least one of location information about each saliency box, a dimension of each saliency box, and a type of a subject included in each saliency box.

5. The method as claimed in claim 4, wherein the extracting comprises:
providing the type of the subject corresponding to each saliency box, and the first set of salient subjects, as input to the NN model;
segmenting, using the NN model, the one or more salient images; and
extracting the one or more salient images along with the boundary information corresponding to each salient subject subjects based on a result of the segmenting.

6. The method as claimed in claim 1, further comprising:
determining whether a quality of the one or more salient images is higher than a predetermined quality threshold value, and
displaying a salient image from among the one or more salient images based on determining that the quality of the one or more salient images is higher than the predetermined quality threshold value.

7. The method as claimed in claim 6, wherein determining the quality of the one or more salient images comprises:
calculating a quality metric value corresponding each salient image from among the one or more salient images,
comparing the quality metric value of each salient image with the predetermined quality threshold value, and
determining whether the quality metric value of each salient image is higher than the predetermined quality threshold value based on a result of the comparing,
wherein the quality metric value indicates the quality of the one or more salient images.

8. An electronic device for performing saliency segmentation for a preview image frame, the electronic device comprising:
one or more processors; and
a memory configured to store instructions which, when executed by the one or more processors, cause the electronic device to:
receive the preview image frame from an imaging unit of the electronic device,
generate a plurality of saliency boxes comprising one or more salient subjects, for each of a plurality of subjects in the preview image frame,
select, from among the plurality of saliency boxes, a set of saliency boxes comprising a first set of salient subjects based on a ranking of each saliency box from among the plurality of saliency boxes, and
extract one or more salient images including a second set of salient subjects along with boundary information of the second set of salient subjects based on a segmentation of images corresponding to each salient subject from among the first set of salient subjects.

9. The electronic device as claimed in claim 8, wherein to generate the plurality of saliency boxes having one or more salient subjects, the instructions further cause the one or more processors to:
provide the preview image frame as input to a neural network (NN) model,
detect, using the NN model, the plurality of subjects in the preview image frame, assign, using the NN model, a score to each subject included in the plurality of subjects in the preview image frame,
detect, using the NN model, the one or more salient subjects from among the plurality of subjects based on the assigned score, and
generate, using the NN model, the plurality of saliency boxes.

10. The electronic device as claimed in claim 8, wherein to select the set of saliency boxes having the first set of salient subjects, the instructions further cause the one or more processors to:
perform an analysis on the plurality of saliency boxes by applying one or more pre-determined ranking parameters to the one or more salient subjects and the plurality of saliency boxes, rank the plurality of saliency boxes based on a result of the analysis, and
select the set of saliency boxes from the plurality of saliency boxes based on the ranking.

11. The electronic device as claimed in claim 10, wherein the first set of salient subjects are selected from the one or more salient subjects, and
wherein the one or more pre-determined ranking parameters include at least one of location information about each saliency box, a dimension of each saliency box, and a type of a subject included in each saliency box.

12. The electronic device as claimed in claim 11, wherein to extract the one or more salient images along with the boundary information of the second set of salient subjects, the instructions further cause the one or more processors to:
provide the type of the subject corresponding to each saliency box and the first set of salient subjects as input to the NN model,
segment, using the NN model, the one or more salient images, and
extract the one or more salient images along with the boundary information corresponding to each salient subject based on a result of the segmenting.

13. The electronic device as claimed in claim 8, wherein the instructions further cause the one or more processors to:
determine whether a quality of the one or more salient images is higher than a predetermined quality threshold value, and
display a salient image from among the one or more salient images based on determining that the quality of the one or more salient images is higher than the predetermined quality threshold value.

14. The electronic device as claimed in claim 13, wherein to determine the quality of the one or more salient images, the instructions further cause the one or more processors to: calculate a quality metric value corresponding to each salient image from among the one or more salient images,
compare the quality metric value of each salient image with the predetermined quality threshold value, and
determine whether the quality metric value of each salient image is higher than the predetermined quality threshold value based on a result of the comparing, wherein the quality metric value indicates the quality of the one or more salient images.

15. A computer-readable recording medium storing computer-executable instructions that, when executed by one or more processors of an electronic device for performing saliency segmentation for a preview image frame, cause the electronic device to:
receive the preview image frame from an imaging unit,
generate a plurality of saliency boxes comprising one or more salient subjects, for each of a plurality of subjects in the preview image frame,
select, from among the plurality of saliency boxes, a set of saliency boxes comprising a first set of salient subjects based on a ranking of each saliency box from among the plurality of saliency boxes, and
extract one or more salient images along with boundary information corresponding to each salient subject from among the first set of salient subjects.
